(19) United States
(12) Patent Application Publication
(10) Pub. No.: US 2015/0160830 A1
(43) Pub. Date: Jun. 11, 2015

(54) INTERACTIVE CONTENT CONSUMPTION THROUGH TEXT AND IMAGE SELECTION

(71) Applicant: Microsoft Corporation, Redmond, WA (US)

(72) Inventors: Zhen Liu, Tarrytown, NY (US); Chien Chih (Jacky) Hsu, Beijing (CN); Jing-Yeu Jaw, Beijing (CN); Chen (Howard) Liu, Beijing (CN)

(73) Assignee: Microsoft Corporation, Redmond, WA (US)

(21) Appl. No.: 14/098,077

(22) Filed: Dec. 5, 2013

(51) Int. Cl. G06F 3/0484; G06N 99/00; G06N 5/04; G06F 3/0481; G06F 3/0482

(52) U.S. Cl. CPC G06F 3/04842; G06F 3/04817; G06F 3/0482; G06N 5/04; G06N 99/005

(57) ABSTRACT

Methods, systems, and computer program products are provided that enable content feedback to be provided in association with displayed content. A user is enabled to interact with the displayed content to indicate a first preference that the displayed content is not preferred and that replacement content be provided, to indicate a second preference that the displayed content is preferred and that similar content to the displayed content be provided, or to indicate a third preference that the displayed content is preferred and that content that is descriptive of the displayed content be provided.

### BACKGROUND

Today, users consume a great amount of content that is accessible on networks such as the Internet via browsers and other applications. Examples of such content include images, text, videos, etc. Frequently, when content is displayed on a display screen in the form of a page (e.g., on a webpage), multiple content items may be displayed together in the page, with each content item occupying a portion of the screen.

Users that view such content may desire to provide feedback. Techniques exist for obtaining feedback on content from users at a page/screen level. For example, content providers sometime use techniques such as a like/dislike button, a feedback/survey form, or a comments submission box to obtain user feedback on a current page/screen. Pre-defined links may also be present that a user can click on to proceed to content displayed on different content pages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that enable users to provide feedback directly on displayed content, at the content level. The users are enabled to interact with the displayed content to indicate various preferences, such as that they do not prefer the content (e.g., “No”), that they prefer the content and would like additional similar content to be provided (e.g., “More”), and/or that they prefer the content and want more information about the displayed content to be provided (e.g., “Deep”). In the first case, replacement content may be provided and displayed. In the second case, additional content that is similar to the displayed content may be provided and displayed. In the third case, additional content providing additional information about the displayed content may be provided and displayed. The replacement/additional content may be displayed in place of the displayed content, or may be otherwise displayed.

For instance, in one implementation, a method is provided, including providing a content for display, and enabling content feedback in association with the displayed content, the enabling including: enabling a user to interact with the displayed content to indicate a first preference that the displayed content is not preferred and be replaced with a display of a replacement content; enabling the user to interact with the displayed content to indicate a second preference that the displayed content is preferred and that additional content regarding a same category and/or same topic as the displayed content be displayed; and enabling the user to interact with the displayed content to indicate a third preference that the displayed content is preferred and that additional content providing additional information about the displayed content be displayed.

In some cases, a graphical user interface (GUI) element may be displayed that includes a first option that may be interacted with to indicate the first preference, and a second option that may be interacted with to indicate the second preference. The GUI element may further include a third option that may be interacted with to indicate the third preference, the third preference may be indicated by a mouse click directly on the content, or the third preference may be indicated in another manner.

Alternatively, touch may be used to enable a preference to be selected. For instance, the first preference may be indicated by a first touch pattern, the second preference may be indicated by a second touch pattern; and the third preference may be indicated by a third touch pattern.

In another alternative, motion sensing may be used to enable a preference to be selected. For example the first preference may be indicated by a first motion pattern, the second preference may be indicated by a second motion pattern, and the third preference may be indicated by a third motion pattern.

In another implementation, a method in a server is provided for selecting next content in response to user interaction with content displayed at a user device, including: receiving from the user device an indication of a first category identifier that indicates a category of the displayed content, a first topic identifier that indicates a topic of the displayed content, a first item identifier that identifies the displayed content, and a user preference indication that indicates a preference of a user regarding the displayed content determined based on an interaction by the user with the displayed content; determining the next content to be displayed at the user device based on the first category identifier, the first topic identifier, the first item identifier, and the user preference indication; and providing the next content to the user device.

In one case, a second category identifier, a second topic identifier, and a second item identifier may be selected when the user preference indication indicates the displayed content is not preferred by the user. In another case, a second topic identifier and a second item identifier may be selected when the user preference indication indicates the displayed content is preferred by the user and that additional content having a same category as the displayed content is desired to be displayed. In still another case, a second item identifier may be selected when the user preference indication indicates the displayed content is preferred by the user and that additional content providing additional information about the displayed content is desired to be displayed. The next content may be selected based on the updated identifiers along with any of the original identifiers that were not updated.

Furthermore, machine learning may be performed on the first category identifier, the first topic identifier, the first item identifier, and the user preference indication to adjust a decision algorithm used to determine the next content.

In still another implementation, a server is configured to select next content in response to user interaction with content displayed at a user device. The server includes a web service and decision logic. The web service is configure to receive from the user device an indication of a first category identifier that indicates a category of the displayed content, a first topic identifier that indicates a topic of the displayed content, a first item identifier that identifies the displayed content, and a user preference indication that indicates a preference of a user regarding the displayed content determined based on an interaction by the user with the displayed content. The decision logic is configured to determine the next content to be displayed at the user device based on the first category identifier, the first topic identifier, the first item identifier, and the user preference indication. The web service configured is to access the next content from content storage and to provide the next content to the user device for display in place of the displayed content in a displayed page. The next content may be displayed in the displayed page in a same size and a same position as was the displayed content.

Furthermore, the server may include machine learning logic configured to perform machine learning on the first category identifier, the first topic identifier, the first item identifier, and the user preference indication to adjust a decision algorithm used by the decision logic.

A computer readable storage medium is also disclosed herein having computer program instructions stored therein that enable users to provide feedback on displayed content, and that enable next content to be selected based on the feedback, according to the embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant arts) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a communication system in which a server device communicates with a user device to provide new content to the user device in response to feedback from a user interacting with displayed content at the user device, according to an example embodiment.

FIG. 2 shows a flowchart providing a process enabling a user to provide feedback directly on displayed content at a user device, according to an example embodiment.

FIG. 3 shows a flowchart providing a process in which a user can indicate various preferences with respect to displayed content, according to an example embodiment.

FIG. 4 shows an example graphical user interface element that enables a user to indicate various preferences with respect to displayed content, according to an embodiment.

FIG. 5 shows a block diagram of a server that is configured to receive a user indicated preference regarding displayed content, and to select new content based thereon, according to an example embodiment.

FIG. 6 shows a flowchart providing a process at a server in which new content may be selected and provided in response to an indication of a categorization of displayed content and a preference regarding the displayed content provided by a user, according to an example embodiment.

FIG. 7 shows a flowchart providing a process at a server in which new content is retrieved based on a user indicating displayed content as not preferred, according to an example embodiment.

FIG. 8 shows a flowchart providing a process at a server in which new content is retrieved based on a user indication that similar content to displayed content is desired, according to an example embodiment.

FIG. 9 shows a flowchart providing a process at a server in which new content is retrieved based on a user indication that content providing additional information for displayed content is desired, according to an example embodiment.

FIG. 10 shows a process for performing machine learning on user feedback provided on displayed content, according to an example embodiment.

FIGS. 11-24 show examples of displayed content, of interactions by users with the displayed content to provide feedback, and of newly displayed content selected based on the feedback, according to embodiments.

FIG. 25 shows a block diagram of an exemplary user device in which embodiments may be implemented.

FIG. 26 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I . Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner

### II. Example Embodiments

Today, users consume a great amount of content that is accessible on networks such as the Internet. Examples of such content include images, text, videos, etc. Frequently, when content is displayed on a display screen in the form of a page (e.g., on a webpage), multiple content items may be displayed together in the page, with each content item occupying a portion of the screen. Users that view such content may desire to provide feedback on the displayed content. Current techniques for obtaining feedback on content from users tend to obtain feedback at a page/screen level. For example, techniques such as a like/dislike button, a feedback/survey form, or a comments submission box may be present to obtain user feedback on a current page/screen. Cookies are also used to collect telemetry from users, and to infer the preferences of users. Pre-defined links may also be present that a user can click on to proceed to content displayed on different content pages.

However, intuitive and straightforward techniques do not tend to exist for allowing a user, as a consumer, to express their preference on a specific content item within a page/screen. Furthermore, techniques do not exist for allowing users to change specific content displayed in a portion of a screen to some other content.

For instance, feedback mechanisms provided at the page/screen level, such as the like/dislike buttons, feedback/comment forms, cookies, etc., do not provide a break-down to the content level accuracy easily. When users click on a URL (uniform resource locator) link or advance an application to a next screen, there is no knowledge regarding the preference of the user about the previously displayed content. For example, whether the user clicked to leave a page does not indicate whether the user liked or disliked the content on the page just left. Furthermore, users typically have to finish reading an entire page/screen before leaving the page/screen for a next page/screen. The user cannot change a portion of the displayed page/screen immediately, without leaving.

Embodiments are described herein that overcome these limitations. For instance, embodiments are described that enable a user to provide feedback at the content level, including providing feedback on a specific content item displayed on a page/screen with multiple content items. Furthermore, the feedback provided by the user may cause the specific content item to be replaced with different content. The different content may be selected based on whether the user feedback indicated the user did not prefer the displayed content item (“No”), indicated the user did prefer the displayed content item and wanted to be displayed similar content (“More”), or that the user did prefer the displayed content item and wanted to be displayed more detailed information regarding the displayed content item (“Deep”). The different content may be displayed in place of the displayed content item, or may be otherwise displayed.

Accordingly, in an embodiment, a new UI (user interface) model is presented that allows users to obtain preferred content through interactions with content providers. For instance, a user may be enabled to quickly obtain desired content by indicating their request through selecting content in the form of text (e.g., keywords, sentences, or paragraphs), images, and/or another form of content from a content provider: With regard to the content, the user may be able to indicate one or more of: “No”—replace this type of content with new (and a possibly different type of) content; “More”—the user likes this type of content and would like to get more relevant content regarding the same (e.g., different photos or news clips of the same topic); and “Deep”—the user likes this content and wants deeper or more detailed information on the content, and/or wants to incur more actions on the current content item. For example, if content item is an advertisement, the selection by the user of “Deep” may indicate purchase behavior (e.g., the user may be interested in purchasing something related to the content item). In another example, if the content item is a news clip, the selection by the user of “Deep” might trigger a feedback input, or the display of full coverage of the news of the news clip.

Example embodiments are described in the following subsections, including embodiments for enabling users to provide feedback directly on displayed content, for selecting and displaying next content based on the feedback, and for exemplary feedback mechanisms.

A. Example Content Consumption System Embodiments

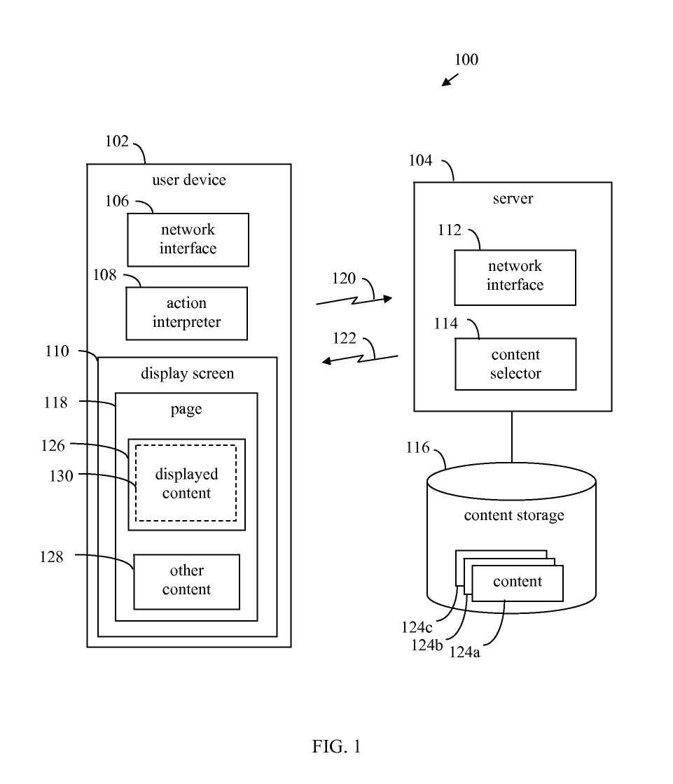

Embodiments may be implemented in devices and servers in various ways. For instance, FIG. 1 shows a block diagram of a communication system 100 in which a server 104 communicates with a user device 102 to provide selected content for display at user device 102 in response to user feedback on content displayed at user device 102, according to an example embodiment. As shown in FIG. 1, user device 102 includes a network interface 106, an action interpreter 108, and a display screen 110. Server 104 includes a network interface 112 and a content selector 114. Server 104 includes or is coupled to a content storage 116. User device 102 and server 104 are described in further detail as follows.

User device 102 may be any type of stationary or mobile computing device, including a mobile computer or mobile computing device (e.g., a Microsoft ® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a RIM Blackberry® device, etc.), a wearable computing device (e.g., a smart watch, smart glasses such as Google® Glass™, etc.), or other type of mobile device (e.g., an automobile), or a stationary computing device such as a desktop computer or PC (personal computer). Server 104 may be implemented in one or more computer systems (e.g., servers), and may be mobile (e.g., handheld) or stationary. Server 104 may be considered a “cloud-based” server, may be included in a private or other network, or may be considered network accessible in another way.

As shown in FIG. 1, content storage 116 includes content, such as first-third content 124a-124c. Each item of stored content may be any type of content, such as textual content (a word, a phrase, a sentence, a paragraph, a document, etc.) or image content (e.g., an image or photo, a video, etc.). Each item of stored content may contain any form of content, such as an advertisement, a news item, etc. Content storage 116 may include one or more of any type of storage mechanism to store content in the form of files or other form, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Network interface 112 of server 104 enables server 104 to communicate over one or more networks, and network interface 106 of user device 102 enables user device 102 to communicate over one or more networks. Examples of such networks include a local area network (LAN), a wide area network (WAN), a personal area network (PAN), or a combination of communication networks, such as the Internet. Network interfaces 106 and 114 may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

Display screen 110 of user device 102 may be any type of display screen, such as an LCD (liquid crystal display) screen, an LED (light emitting diode) screen such as an organic LED screen, a plasma display screen, or other type of display screen. Display screen 110 may be integrated in a single housing of user device 102, or may be a standalone display. As shown in FIG. 1, display screen 110 may be used to display content at user device 102. For instance, a user of user device 102 may interact with a user interface of user device 102 to browse content, and cause content to be displayed by display screen 110. For instance, content may be displayed by display screen 110 contained in a page 118, such as a web page rendered by a web browser, or content may be displayed in other form by another application. As shown in FIG. 1, display screen 110 may display displayed content 126 and other content 128. Displayed content 126 and other content 128 may each include one or more content items in the form of textual content or image content. In the example of FIG. 1, displayed content 126 is configured to be able to be interacted with by a user of user device 102 to provide feedback on displayed content 126, according to an embodiment. For example, as shown in FIG. 1, displayed content 126 may include a feedback interface 130 that enables a user to provide feedback on displayed content 126, such as by mouse clicks (e.g., to a displayed pop up menu, one or more virtual buttons, etc.), by touching display screen 110, by motion sensing, by speech recognition, and/or by other user interface interaction. Other content 128 may optionally be present, and may also be configured to be interacted with by a user to provide feedback thereon, or may not be configured to provide feedback.

Action interpreter 108 is configured to interpret the feedback of the user provided to displayed content 126 using feedback interface 130. For example, as described elsewhere herein, the user may provide feedback to displayed content 126 in the form of not preferring displayed content 126 (e.g., not wanting to view displayed content 126, but wanting to display alternative content instead), referred to herein as a feedback selection of “No”; preferring displayed content 126 and wanting to view additional similar content, referred to herein as a feedback selection of “More”; and preferring displayed content 126 and wanting to view additional content that is more descriptive of displayed content 126, referred to herein as a feedback selection of “Deep”. Action interpreter 108 is configured to receive the feedback provided to feedback interface 130 by the user, and provide the feedback to network interface 106 to be transmitted to server 104.

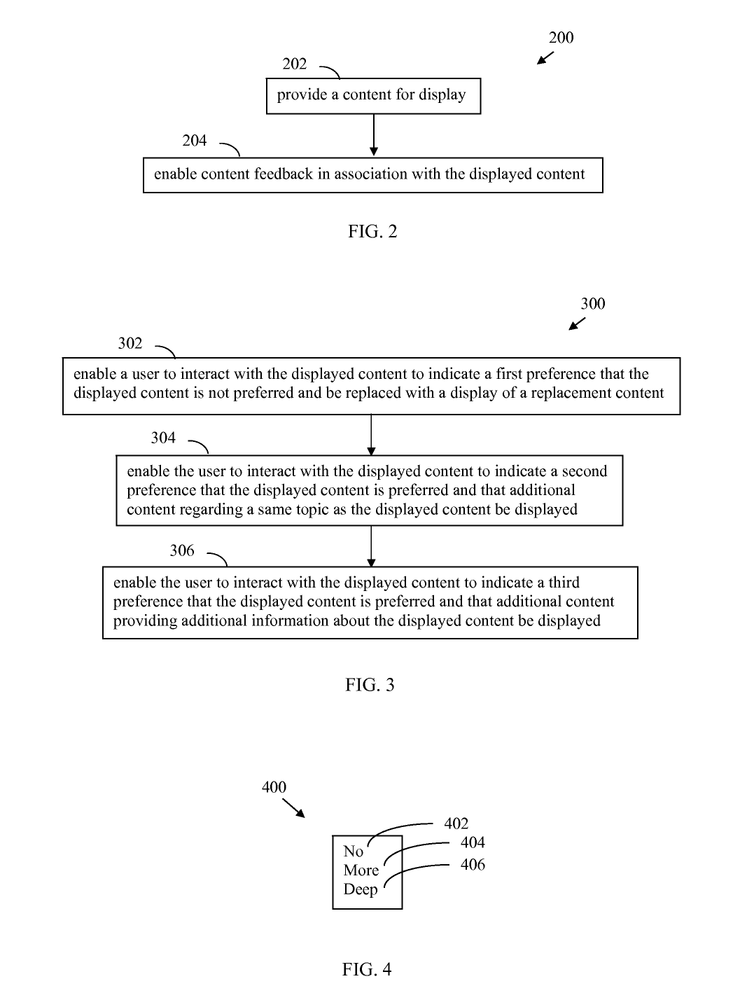

As such, in an embodiment, user device 102 may operate according to FIG. 2. FIG. 2 shows a flowchart 200 providing a process that enables a user to provide feedback directly on displayed content at a user device, according to an example embodiment. Flowchart 200 is described as follows. Further structural and operational embodiments will be apparent to persons skilled in the relevant art(s) based on the following description.

Flowchart 200 begins with step 202. In step 202, content is provided for display. For instance, as shown in FIG. 1, display screen 110 of user device 102 may display displayed content 126, and optionally may display further content such as other content 128. Such content may be displayed in page 118 or in other form.

In step 204, content feedback is enabled in association with the displayed content. For instance, as described above, user device 102 may provide feedback interface 130 in association with displayed content 126 to enable a user of user device 102 to provide feedback on displayed content 126. Such feedback may be received by action interpreter 108.

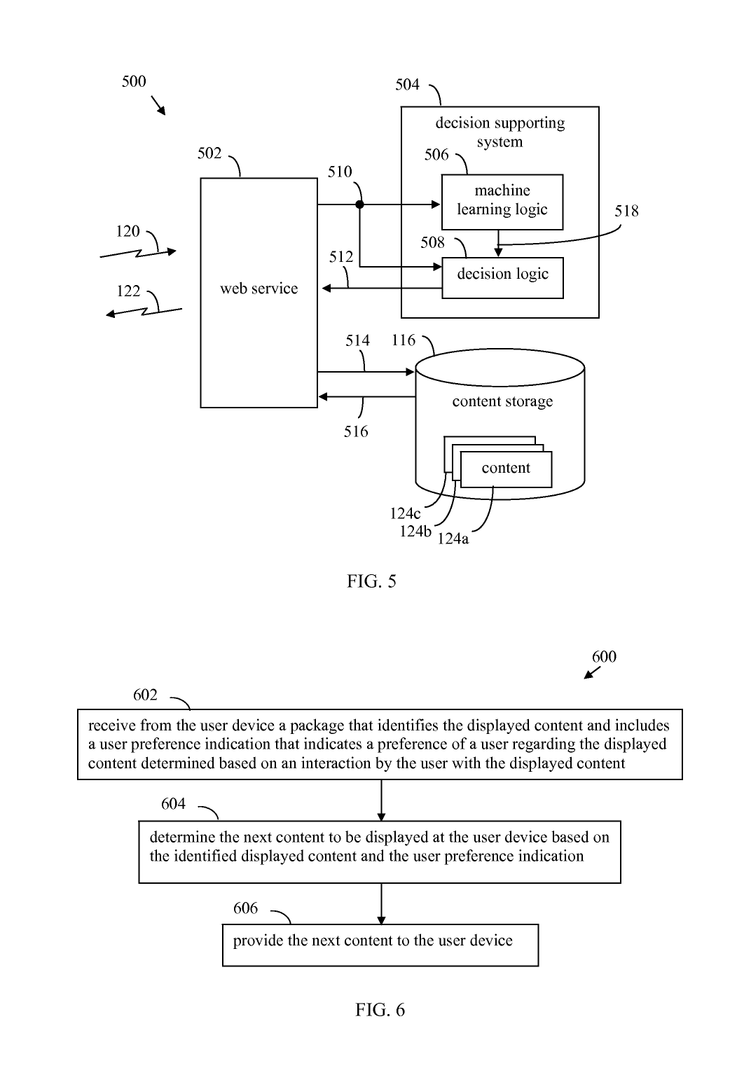

FIG. 3 shows a flowchart 300 providing a process in which a user can indicate various preferences with respect to displayed content, according to an example embodiment. For instance, flowchart 300 may be performed as an example of step 204 of flowchart 200 in FIG. 2. Flowchart 300 is described as follows. Further structural and operational embodiments will be apparent to persons skilled in the relevant art(s) based on the following description.

Flowchart 300 begins with step 302. In step 302, a user is enabled to interact with the displayed content to indicate a first preference that the displayed content is not preferred and be replaced with a display of a replacement content. For example, as described above with respect to FIG. 1, the user of user device 102 may be enabled to interact with feedback interface 130 to indicate the “No” preference with respect to displayed content 126.

In step 304, the user is enabled to interact with the displayed content to indicate a second preference that the displayed content is preferred and that additional content regarding a same topic as the displayed content be displayed. For example, as described above, the user of user device 102 may be enabled to interact with feedback interface 130 to indicate the “More” preference with respect to displayed content 126.

In step 306, the user is enabled to interact with the displayed content to indicate a third preference that the displayed content is preferred and that additional content providing additional information about the displayed content be displayed. For example, as described above, the user of user device 102 may be enabled to interact with feedback interface 130 to indicate the “Deep” preference with respect to displayed content 126.

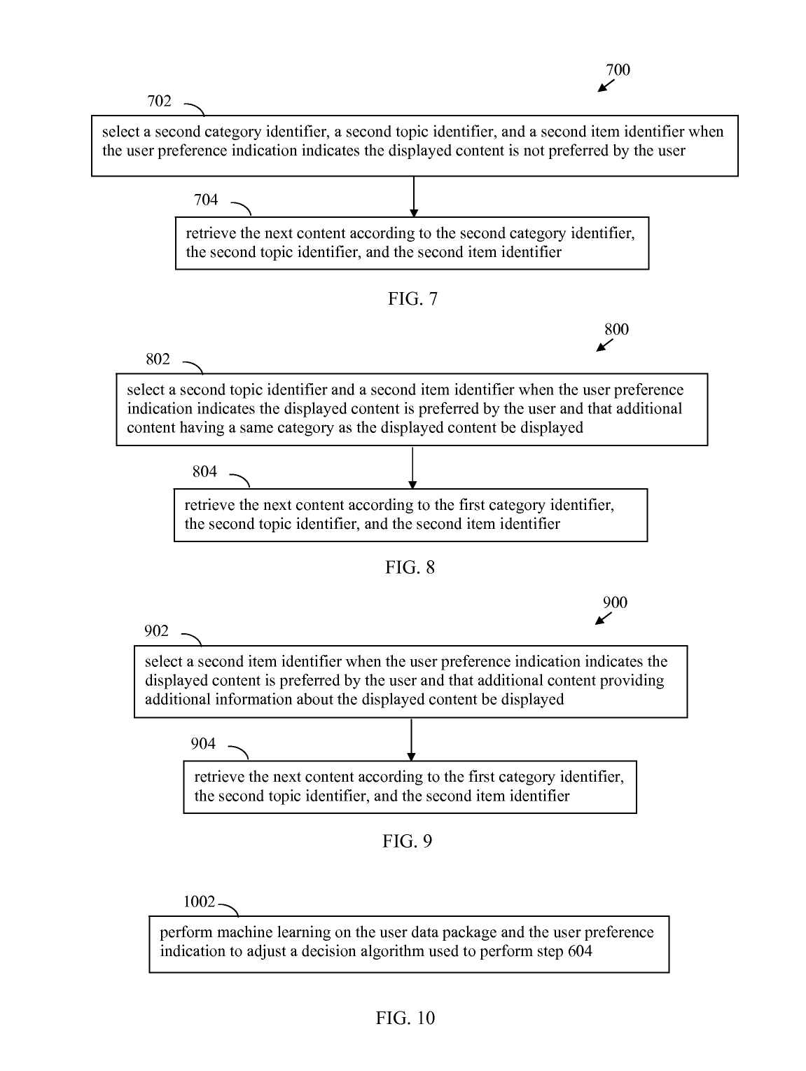

As described above, feedback interface 130 may be configured to enable the user to provide their feedback in any suitable form, including by one or more of mouse clicks, touch, motion, voice, etc. For instance, FIG. 4 shows an example graphical user interface (GUI) element 400 that enables a user to indicate various preferences with respect to displayed content, according to an embodiment. As shown in FIG. 4, GUI element 400 may be a list or a pop up menu that is present when a user interacts with displayed content 126 of FIG. 1. For instance, when the user hovers a mouse pointer over displayed content 126, touches displayed content 126 on display screen 110, makes a particular pre-determined hand motion, speaks a predetermined one or more words, or interacts with displayed content 126 via feedback interface 130 in another way, GUI element 400 may be displayed adjacent to or over displayed content 126 in display screen 110. The user may then provide a subsequent action, such as a click, a touch, a motion, or a speaking of the appropriate word, to indicate their feedback of one of “No”, “More”, or “Deep” (or other suitable labels provided in GUI element 400). Note that GUI element 400 is shown for purposes of illustration, and in other embodiments may have other suitable forms, as would be apparent to persons skilled in the relevant art(s) based on the teachings herein (e.g., a radio button, a pull down menu, etc.).

As shown in FIG. 1, network interface 106 of user device 102 may transmit a content feedback signal 120 to server 104 that indicates the feedback provided by the user to displayed content 126 and received by action interpreter 108. Content feedback signal 120 may also include identifying information for displayed content 126. As shown in FIG. 1, network interface 112 of server 104 may receive content feedback signal 120. Content selector 114 at server 104 is configured to select next content to be displayed for displayed content 126 based on the feedback received in content feedback signal 120.

For instance, if content feedback signal 120 indicates that the user did not prefer displayed content 126 (e.g., “No”), content selector 114 may select content that is not related to displayed content 126 (e.g., a different category and/or topic of content). If content feedback signal 120 indicates that the user did prefer displayed content 126, and thus desires additional similar content (e.g., “More”), content selector 114 may select content that is related to displayed content 126 (e.g., categorized in a same category, and optionally in a same topic). If content feedback signal 120 indicates that the user did prefer displayed content 126, and thus desires content that is more descriptive of displayed content 126 (e.g., “Deep”), content selector 114 may select content that is closely related to displayed content 126 (e.g., categorized in a same category, and a same topic of content under the same category).

Content selector 114 may retrieve the selected next content from content storage 116 (e.g., one or more of content 124a-124c and/or other content stored in content storage 116), and provide the selected next content to network interface 112 to transmit to user device 102. As shown in FIG. 1, network interface 112 transmits a selected next content signal 122 from server 104 that includes the next content selected by content selector 114 in response to content feedback signal 120. Network interface 106 of user device 102 may receive selected next content signal 122. The selected next content received in selected next content signal 122 may be displayed in page 118 by display screen 110 for the user to view. In an embodiment, the selected next content may be displayed in page 118 in place of displayed content 126, in a same size and position in page 118 as displayed content 126 was displayed.

In this manner, a user of user device 102 is enabled to provide content-specific feedback on content that may be displayed in a screen/page side-by-side with other content. Furthermore, the feedback is more than a mere like/dislike type of content, but also indicates further types of content that the user may desire to be displayed (e.g., different content, similar content, content that is more descriptive, etc.). Still further, the content that is selected in response to the feedback may be displayed in place of the displayed content that the feedback was provided on. Thus, a portion of a displayed page/screen may be changed based on user feedback, while the rest of the page/screen does not change.

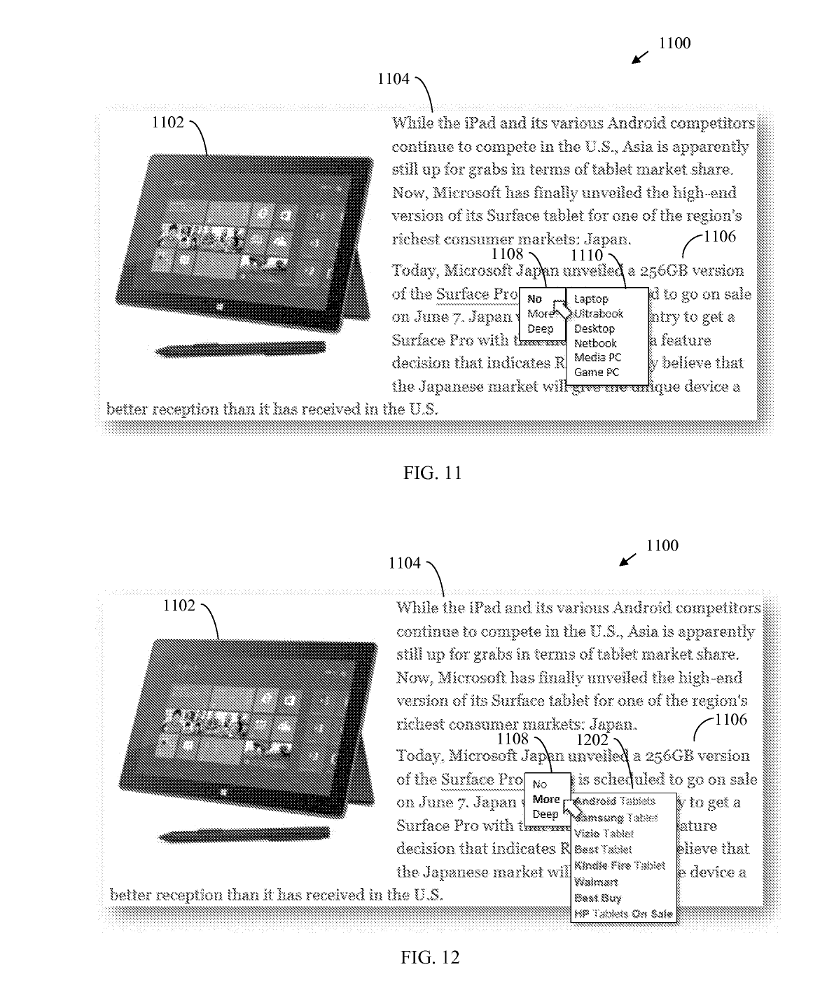

In embodiments, server 104 may be configured in various ways to perform its functions. FIG. 5 shows a block diagram of a server 500 that is configured to receive a user indicated preference regarding displayed content, and to select new content based thereon, according to an example embodiment. Server 500 is an example of server 104 shown in FIG. 1. As shown in FIG. 5, server 500 includes a web service 502, a decision supporting system 504, and content storage 116. Furthermore, decision supporting system 504 includes machine learning logic 506 and decision logic 508.

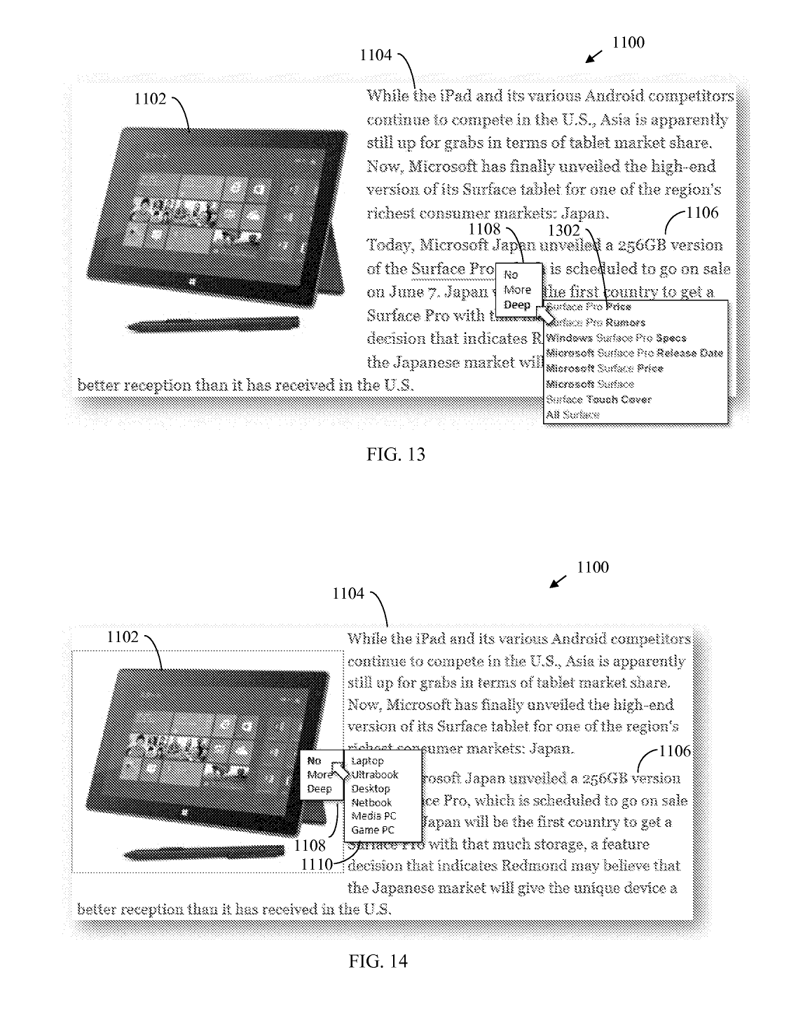

For ease of illustration, server 500 is described with reference to FIG. 6. FIG. 6 shows a flowchart 600 providing a process in which new content is selected and provided in response to a categorization of and feedback provided regarding displayed content, according to an example embodiment. In an embodiment, server 500 may operate according to flowchart 600. Flowchart 600 and server 500 are described as follows. Further structural and operational embodiments will be apparent to persons skilled in the relevant art(s) based on the following description.

Flowchart 600 begins with step 602. In step 602, a package is received from the user device that identifies the displayed content and includes a user preference indication that indicates a preference of a user regarding the displayed content determined based on an interaction by the user with the displayed content. For example, as shown in FIG. 5, web service 502 receives content feedback signal 120 from user device 102. Content feedback signal 120 may include a user data package that identifies displayed content 126, and indicates the feedback provided by the user to displayed content 126.

Displayed content 126 may be identified in the package in various ways, such as by one or more identifiers (e.g., numerical, alphanumerical, etc.) and/or other identifying information. For instance, in an embodiment, each content item may be classified in topic of a category, where multiple categories may be present, and each category includes multiple topics. Thus, each content item, such as displayed content 126, content 124a, content 124b, content 124c, etc., may be categorized by a category and topic. For example, in an embodiment, each content item may have an associated category identifier that indicates a category of the content item, may have an associated topic identifier that indicates a topic of the content item, and may have an associated content identifier that specifically (e.g., uniquely) identifies the content item itself

Accordingly, content feedback signal 120 may include an indication of a first category identifier that indicates a category of displayed content 126, a first topic identifier that indicates a topic of displayed content 126, a first item identifier that identifies displayed content 126, and a user preference indication provided as the feedback provided by the user to displayed content 126.

Categories, topics, and content may be organized in a hierarchy in any manner, with categories at the top (broadest) and content at the bottom (most specific). Any number of different types of categories and topics may be present. Examples of categories may include news, consumer products, automobiles, technology, etc. Examples of topics under the news category may include entertainment, politics, sports, etc. Examples of topics under the consumer products category may include luxury, clothing, etc. Examples of topics under the automobiles category may include Ford, Lexus, Honda, sports cars, etc. Thus, a topic is categorized in the hierarchy as a subset of a category. Examples of content under the Ford topic may include the Focus automobile, the Fusion automobile, the Escape automobile (and/or further models of automobiles manufactured by Ford Motor Company). Thus, content is categorized in the hierarchy as an element of a topic.

Note that in other embodiments, a hierarchy may include more or fewer hierarchy levels than three as in the present example (e.g., category, topic, item). Thus, content items may be defined by more or fewer identifiers than the category identifier, topic identifier, and item identifier.

Note that the category identifier, topic identifier, and item identifier for a particular content item may be determined and assigned to the content item at any time. For instance, content 124a, content 124b, and content 124c may each have a corresponding item identifier assigned to them and associated with them in content storage 116 (e.g., by web service 502 of FIG. 5 or by other entity), prior to their being transmitted for display by a user device. Such an item identifier may be stored in metadata of the content item, or may be otherwise associated with the content item.

Furthermore, content 124a, content 124b, and content 124c may each have a corresponding category identifier and/or topic identifier assigned to them and associated with them in content storage 116 (e.g., automatically by web service 502 of FIG. 5, by a content developer, or by other entity), prior to their being transmitted for display by a user device. Alternatively, a category identifier and/or topic identifier may be assigned and associated with a content item after being transmitted to a user device, and thus may be assigned by the user device (e.g., by action interpreter 108 of FIG. 1 or by other entity).

For instance, page 118 may have an associated category identifier and topic identifier stored in code (e.g., HTML code, XML code, etc.) of page 118. For instance, the category identifier and topic identifier may be indicated as a tag, may be included in header information, or may be otherwise included in page 118. When particular content is displayed in page 118, such as displayed content 126, the particular content may have an assigned content identifier, and may take on the category and topic identifier of page 118.

In another embodiment, the particular content may be analyzed at server 104 (e.g., by web service 502) or at user device 102 (e.g., by action interpreter 108) to determine a category and topic in which the content belongs, and to thereby select the corresponding category identifier and topic identifier for the content. For instance, in one example, displayed content 126 may include text, such as one or more words, sentences, or paragraphs. The text may be parsed for one or more keywords using one or more keyword parsing techniques that will be known to persons skilled in the relevant art(s). The keywords may be applied to a first table that lists categories on one axis, and lists keywords on another axis. The category of the column (or row) that is determined by analysis of the first table to include the most keywords found in the parsed text may be selected as the category displayed content 126. Thus, the category identifier for the selected category may be associated with displayed content 126. Similarly, using a second table that lists topics on one axis, and lists keywords on another axis may be used to determine the topic, and thereby the topic identifier, for displayed content 126. In other embodiments, other types of data structures than tables may be used to determine category and topic identifiers for content, such as arrays, data maps, etc.

In another example, displayed content 126 may include one or more images (e.g., including a video, which is a stream of images). In a similar manner as described above, the image(s) can be analyzed for keywords and/or for objects (e.g., people, trees, clothing, automobiles, consumer products, luxury items, etc.), and the determined keywords and/or objects may be compared to one or more data structures to determine category and topic identifiers for displayed content 126.

Such determinations may be performed at user device 102 and/or server 104. The determined category identifier and topic identifier may be stored in metadata of the content item, or may be otherwise associated with the content item.

Referring back to FIG. 6, in step 604 of flowchart 600, the next content to be displayed at the user device is determined based on the identified displayed content and the user preference indication. Referring to FIG. 5, in an embodiment, decision logic 508 may be configured to determine next content for display at the user device based on the identified displayed content and the user preference indication.

For instance, as shown in FIG. 5, decision logic 508 receives a user data package 510 from web service 502. User data package 510 indicates the content on which feedback was provided (e.g., displayed content 126 of FIG. 1), and indicates the feedback. In an embodiment, user data package 510 may include the category identifier, the topic identifier, and the item identifier for displayed content 126 as the identifying information. Furthermore, user data package 510 may include an indication of “No”, “More”, or “Deep”, or other suitable feedback provided by the user by interacting with displayed content 126. Decision logic 508 may determine the next content for display, which may be retrieved from content storage 116, based on the identifiers and feedback. As shown in FIG. 5, decision logic 508 generates selected content indication 512, which indicates the determined next content.

For example, if an indication of “No” is received, decision logic 508 may select new content for display that is unrelated to displayed content 126. For instance, decision logic 508 may select new content from a different category than displayed content 126. If an indication of “More” is received, decision logic 508 may select new content for display that is related to displayed content 126. Decision logic 508 may select new content from a same category of content as displayed content 126, but from a same or different topic than displayed content 126. If an indication of “Deep” is received, decision logic 508 may select new content for display that is closely related to displayed content 126. For instance, decision logic 508 may select new content from a same category of content and a same topic as displayed content 126.

Referring back to FIG. 6, in step 606, the next content is provided to the user device. For instance, as shown in the example of FIG. 5, web service 502 receives selected content indication 512 from decision logic 508. Web service 502 is configured to retrieve the next content indicated in selected content indication 512 from content storage 116. Web service 502 may issue a content retrieval request 514 that identifies the next content. Content storage 116 receives content retrieval request 514, and in response thereto, accesses the next content in storage, and provides the next content to web service 502 as selected content 516. Web service 502 may transmit selected next content signal 122 from server 500, which includes the next content selected in response to content feedback signal 120. As described above, the user device (e.g., user device 102 of FIG. 1) receives selected next content signal 122 and displays the next content contained therein to the user.

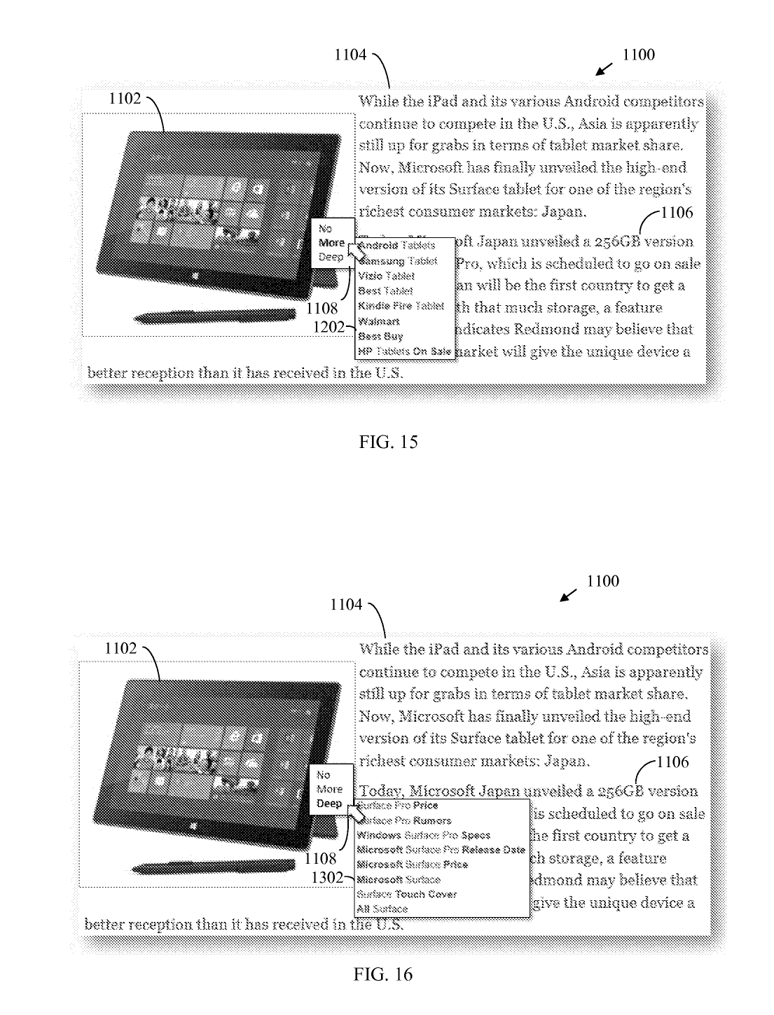

In embodiments, decision logic 508 may operate in various ways to perform step 604 of flowchart 600 (FIG. 6). In an example embodiment, decision logic 508 may operate according to FIGS. 7-9, which show flowcharts for selecting next content based on received content identifiers and user feedback. FIGS. 7-9 are described as follows.

For example, FIG. 7 shows a flowchart 700 providing a process at a server in which new content is retrieved based on a user indicating displayed content as not preferred, according to an embodiment. For instance, user data package 510 may include a user preference indication that indicates the user did not prefer displayed content 126 (e.g., a feedback of “No”). In such case, in step 702 of flowchart 700, a second category identifier, a second topic identifier, and a second item identifier are selected when the user preference indication indicates the displayed content is not preferred by the user. In an example, the category, topic, and item identifiers received in user data package 510 may be represented as (where “n” is an index):

CID(n)=Current category identifier

TID(n)=Current topic identifier

IID(n)=Current item identifier

In the event that the user preference indication indicates that the user did not prefer displayed content 126, each identifier may be recalculated to a next value, as represented below:

CID(n+1)=Next(CID(n))

TID(n+1)=Next (TID(n))

IID(n+1)=Next ((IID(n))

where:

Next( )=a decision algorithm implemented by decision logic 508 to select next content. In this manner, the next content may be identified by the new values for the category, topic, and item identifiers.

In step 704, the next content is retrieved according to the second category identifier, the second topic identifier, and the second item identifier. Continuing the example from step 702, in an embodiment, decision logic 508 may provide the new category, topic, and item identifiers to web service 502 in selected content indication 512, and web service 502 may retrieve the next content item identified by the new category, topic, and item identifiers from content storage 116.

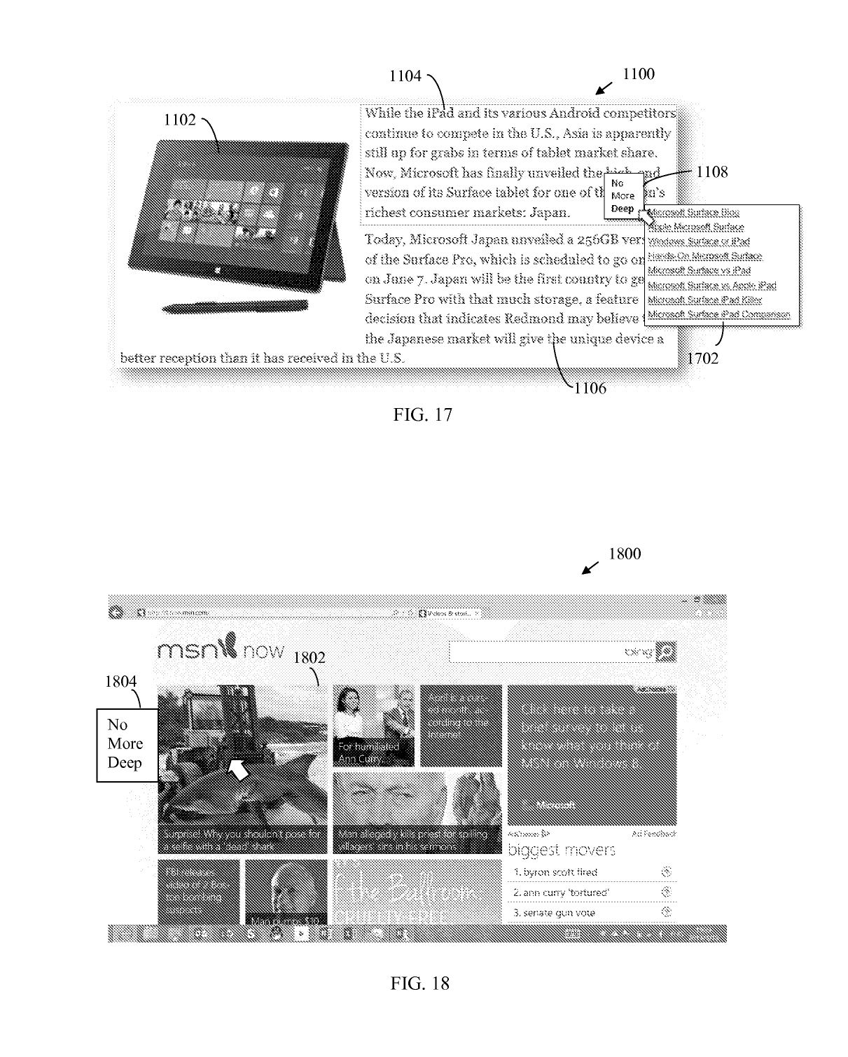

FIG. 8 shows a flowchart providing a process at a server in which new content is retrieved based on a user indication that similar content to displayed content is desired, according to an example embodiment. For instance, user data package 510 may include a user preference indication that indicates the user did prefer displayed content 126 and wanted similar content (e.g., a feedback of “More”). In such case, in step 802 of flowchart 800, a second topic identifier and a second item identifier are selected when the user preference indication indicates the displayed content is preferred by the user and that additional content having a same category as the displayed content be displayed. In this example, the topic and item identifiers may be recalculated to next values, while the category identifier is not changed, as represented below:

CID(n+1)=CID(n)

TID(n+1)=Next (TID(n))

IID(n+1)=Next ((IID(n))

In this manner, the next content may be identified by the new values for the topic and item identifiers, and the same, unchanged category identifier.

In step 804, the next content is retrieved according to the first category identifier, the second topic identifier, and the second item identifier. Continuing the example from step 802, in an embodiment, decision logic 508 may provide the unchanged category identifier and the new topic and item identifiers to web service 502 in selected content indication 512, and web service 502 may retrieve the next content item identified by these identifiers from content storage 116.

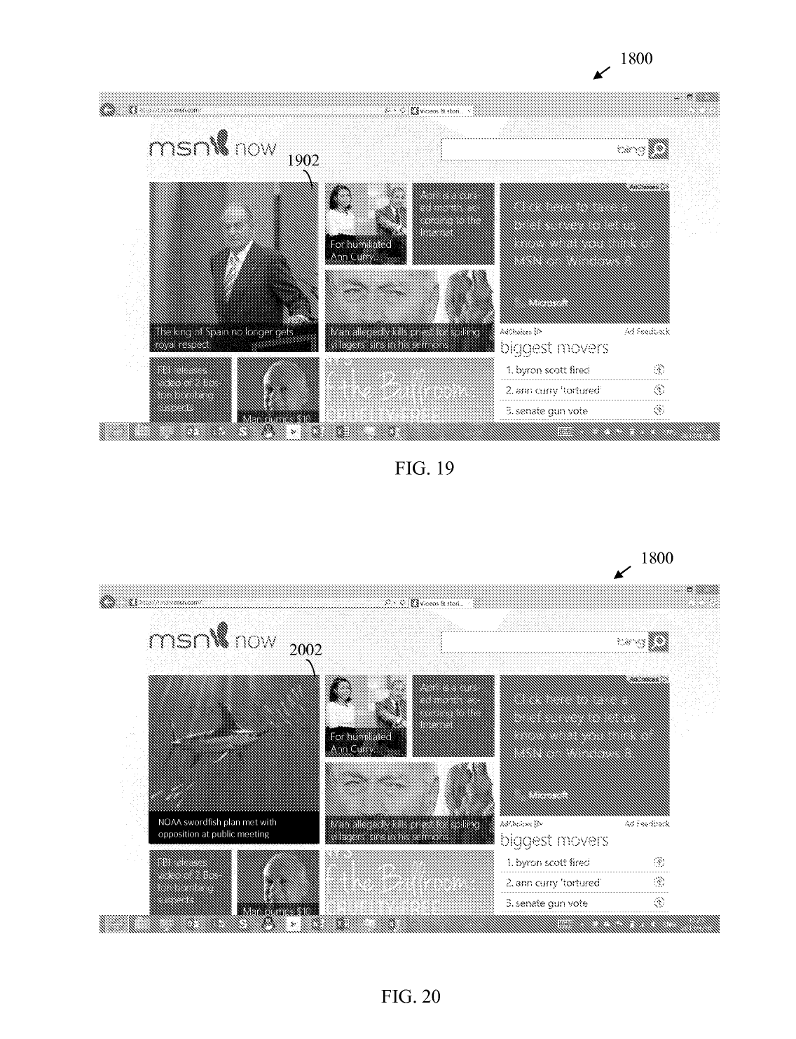

FIG. 9 shows a flowchart providing a process at a server in which new content is retrieved based on a user indication that content providing additional information for displayed content is desired, according to an example embodiment. For instance, user data package 510 may include a user preference indication that indicates the user did prefer displayed content 126 and wanted content more descriptive of the displayed content (e.g., a feedback of “Deep”). In such case, in step 902 of flowchart 900, a second item identifier is selected when the user preference indication indicates the displayed content is preferred by the user and that additional content providing additional information about the displayed content be displayed. In this example, the index for the item identifier may be recalculated to a next value, while the category and topic identifiers are not changed, as represented below:

CID(n+1)=CID(n)

TID(n+1)=TID(n)

IID(n+1)=Next ((IID(n))

In this manner, the next content may be identified by the new value for the item identifier, and the same, unchanged category and topic identifiers.

In step 904, the next content is retrieved according to the first category identifier, the second topic identifier, and the second item identifier. Continuing the example from step 902, in an embodiment, decision logic 508 may provide the unchanged category and topic identifiers and the new item identifier to web service 502 in selected content indication 512, and web service 502 may retrieve the next content item identified by these identifiers from content storage 116.

Note that in an embodiment, machine learning and/or other learning techniques may be performed to improve decisions made by decision logic 508. For instance, as shown in FIG. 5, machine learning logic 506 may receive user data package 510. Machine learning logic 506 may use the contents of user data package 510 to improve a decision algorithm used by decision logic 506 to select next content. For instance, machine learning logic 506 may use machine learning to gradually adjust the decision algorithm to be more precise.

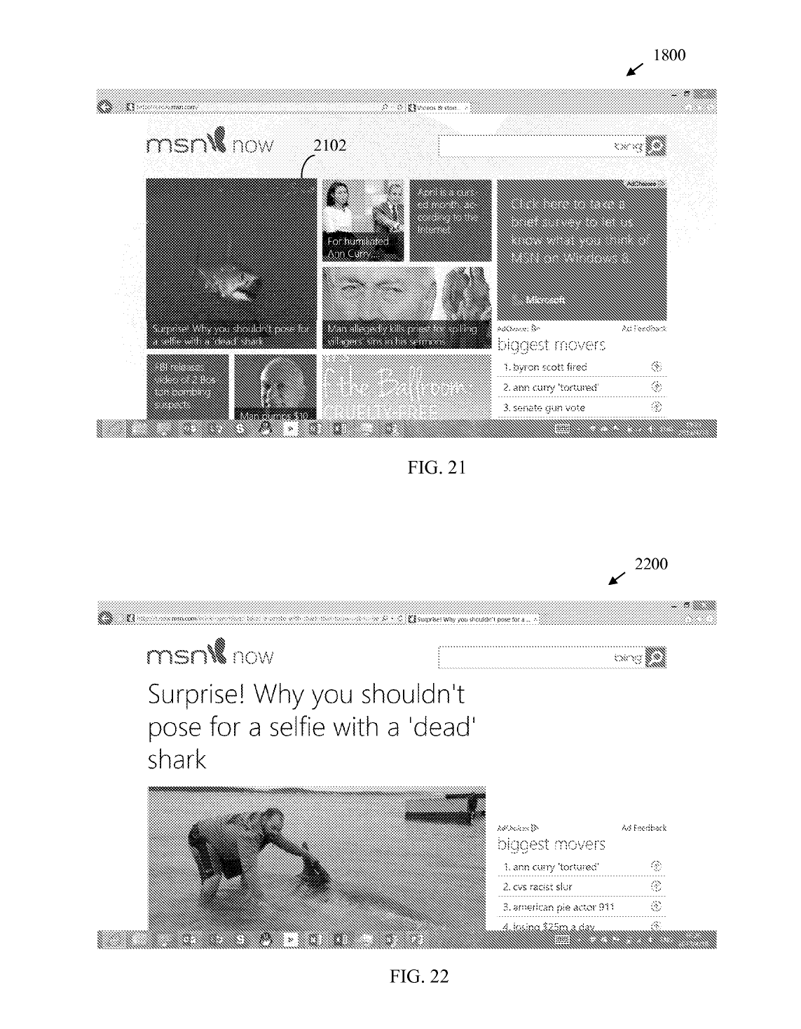

Machine learning logic 506 may operate according to FIG. 10. FIG. 10 shows a step 1002 providing a process for performing machine learning on user feedback provided on displayed content, according to an example embodiment. In step 1002, machine learning is performed on the user data package and the user preference indication to adjust a decision algorithm used to perform step 604.

As shown in FIG. 5, machine learning logic 506 may output a modified decision algorithm 518, which is received by decision logic 508. Modified decision algorithm 518 may be used to perform future determinations of next content.

B. Example Content Feedback Interface Embodiments

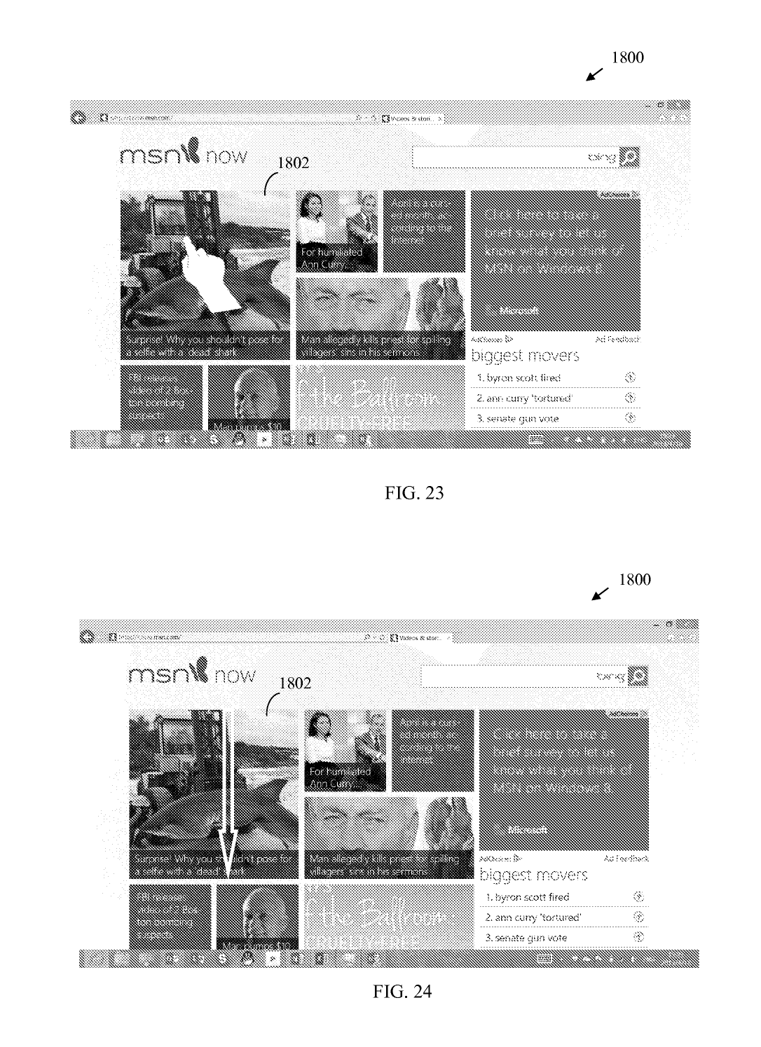

As described above, users are enabled to provide feedback directly on displayed content to cause additional content to be selected and displayed. Example techniques for providing feedback on displayed content to cause additional content to be selected and displayed are described as follows. For instance, FIGS. 11-24 show examples of displayed content, of interactions by users with the displayed content to provide feedback, and of newly displayed content selected based on the feedback, according to embodiments. FIGS. 11-24 are shown for exemplary purposes, and are not intended to be limiting. Content may be displayed, and feedback may be provided thereon by users, in any suitable manner, as would be apparent to persons skilled in the relevant art(s) from the teachings herein. FIGS. 11-24 are described as follows.

In one set of examples, FIGS. 11-17 each show a page 1100 in which an image 1102 of a tablet computer is shown on a left side, and first and second paragraphs 1104 and 1106 of text are shown on a right side. In FIG. 11, a user interacts with an interface device (e.g., a touch pad, a mouse, etc.) to move a pointer over the text/keywords “Surface Pro” in second paragraph 1106 to interact with the keywords. For example, the user may perform a click using the interface device to cause a pop up menu 1108 to be presented over page 1100 with respect to the keywords. Pop up menu 1108 is similar to GUI element 400 of FIG. 4, and enables a user to indicate their feedback of one of “No”, “More”, or “Deep” with respect to the keywords “Surface Pro.” For instance, as shown in FIG. 11, if the user selects (e.g., clicks on, hovers over, or otherwise interacts with) the option of “No” in pop up menu 1108, indicating they do not prefer the content of “Surface Pro,” a second pop up menu 1110 (or other UI element) may be presented that enables the user to select alternative content to “Surface Pro” for display. In this example, “Surface Pro” may be categorized under the category of computers, and sub-category/topic of tablet computers. Thus decision logic 508 (FIG. 5) may select keywords for display that are under the category of computers, but related to other topics than tablets. In the example of FIG. 11, decision logic 508 may select keywords such as “Laptop”, “Ultrabook”, “Desktop”, etc., for display, which may each be selected by the user to cause additional content to be displayed.

In FIG. 12, alternatively to selecting “No”, the user may select the option of “More” in pop up menu 1108, indicating they do prefer the content of “Surface Pro,” and want to see similar keywords. As such, a third pop up menu 1202 may be presented that enables the user to select related content to “Surface Pro” for display. In this example, decision logic 508 may select keywords for display that are under the category of computers, and included in the topic of tablet computers. For instance, decision logic 508 may select keywords such as “Android Tablets”, “Samsung Tablet”, etc., for display, which may each be selected by the user to cause additional content to be displayed.

In FIG. 13, the user may instead select the option of “Deep” in pop up menu 1108, indicating they do prefer the content of “Surface Pro,” and want to see more descriptive keywords regarding “Surface Pro”. As such, a fourth pop up menu 1302 may be presented that enables the user to select more descriptive content to “Surface Pro” for display. In this example, decision logic 508 may select keywords for display that are under the category of computers, and topic of tablet computers, and more descriptive of “Surface Pro.” For instance, decision logic 508 may select keywords such as “Surface Pro Price”, “Surface Pro Rumors”, etc., for display, which may each be selected by the user to cause additional content to be displayed.

In the example of FIGS. 14-16, the user interacts with image 1102 to provide feedback by moving a pointer over image 1102. The user may perform a click using the interface device to cause pop up menu 1108 to be presented over page 1100 with respect to image 1102. In FIG. 14, the user selects the option of “No” in pop up menu 1108, indicating they do not prefer the content of image 1102. As such, second pop up menu 1110 may be presented that enables the user to select alternative content to image 1102 for display. In this example, image 1102 shows a Microsoft® Surface Pro™ computing device, and thus image 1102 may be categorized under the category of computers, and under the sub-category/topic of tablet computers. Thus decision logic 508 (FIG. 5) may select other computers for listing in pop up menu 1110 that are under the category of computers, but related to other topics than tablets. In the example of FIG. 14, decision logic 508 may select “Laptop”, “Ultrabook”, “Desktop”, etc., for display, which may each be selected by the user to cause additional content to be displayed.

In FIG. 15, the user may instead select the option of “More” in pop up menu 1108, indicating they do prefer image 1102, and want to see similar content. As such, third pop up menu 1202 may be presented that enables the user to select related content to image 1102 for display. In this example, decision logic 508 may select images or other content for display that are under the category of computers, and included in the topic of tablet computers. For instance, decision logic 508 may list names of content such as “Android Tablets”, “Samsung Tablet”, etc., for display, which may each be selected by the user to cause additional content to be displayed.

In FIG. 16, the user may instead select the option of “Deep” in pop up menu 1108, indicating they do prefer image 1102 and want to see more descriptive content regarding image 110. As such, fourth pop up menu 1302 may be presented that enables the user to select content that is more descriptive of image 1102 for display. In this example, decision logic 508 may select images or other content for display that are under the category of computers, and topic of tablet computers, and more descriptive of image 1102. For instance, decision logic 508 may select content having names such as “Surface Pro Price”, “Surface Pro Rumors”, etc., for display, which may each be selected by the user to cause additional content to be displayed.

In FIG. 17, the user interacts with first paragraph 1104 to provide feedback by moving a pointer over first paragraph 1104. The user may perform a click using the interface device to cause pop up menu 1108 to be presented over page 1100 with respect to first paragraph 1104. In FIG. 14, the user selects the option of “Deep” in pop up menu 1108, indicating they do prefer first paragraph 1104 and want to see more descriptive content regarding first paragraph 1104. As such, a fifth pop up menu 1702 may be presented that enables the user to select content that is more descriptive of first paragraph 1104 for display. In this example, web service 502, decision logic 508, action interpreter 108, or other entity may analyze text of first paragraph 1104, such as by parsing the text as described above, to determine a category and topic of first paragraph 1104. For instance, computers may be determined as a category of first paragraph 1104, and Microsoft® Surface™ may be determined as the topic of first paragraph 1104. As such, decision logic 508 may select images or other content for display that are under the category of computers, and topic of Microsoft® Surface™, and are more descriptive of first paragraph 1104. For instance, decision logic 508 may select content having names such as “Microsoft Surface Blog”, “Apple Microsoft Surface”, etc., for display, which may each be selected by the user to cause additional content to be displayed.

In a similar manner as described above, the “No” and “More” options may be selected in pop up menu 1108 in FIG. 17 to cause additional content to be selected for display.

In another set of examples, FIGS. 18-24 each show a page 1800 in which various forms of content are present, including text and images. A first image 1802 is present in an upper left corner of page 1800 that shows a picture of a shark and includes a textual caption of “Surprise! Why you shouldn't pose for a selfie with a ‘dead’ shark.” FIGS. 18-24 show examples of interactions with image 1802 to provide feedback, and examples of next content selected based on the feedback. FIGS. 18-22 relate to non-touch embodiments for providing feedback, FIGS. 23 and 24 relate to touch embodiments for providing feedback.

In FIG. 18, a user interacts with an interface device (e.g., a touch pad, a mouse, etc.) to move a pointer over image 1802 to provide feedback on image 1802. For example, the user may perform a click using the interface device to cause a pop up menu 1804 to be presented over page 1800 with respect to image 1802. Pop up menu 1804 is similar to GUI element 400 of FIG. 4, and enables a user to indicate their feedback of one of “No”, “More”, or “Deep” with respect to image 1802. For instance, as shown in FIG. 18, if the user selects the option of “No” in pop up menu 1804, indicating they do not prefer the content of “image 1802, replacement content for image 1802 may be automatically selected and displayed in place of image 1802. In this example, image 1802 may be categorized under the category of news, with a sub-category/topic of sea life. Thus decision logic 508 (FIG. 5) may select content for display that is under the category of news, but related to other topics than sea life. For instance, FIG. 19 shows page 1800 with an image 1902 displayed in place of image 1802. Image 1902 is displayed in the same position in page 1800 as was image 1802, and has a same size as image 1802. However, image 1902 is categorized under the category of news and topic of international (showing the king of Spain), and thus relates to a different topic than image 1802.

Alternatively in FIG. 18, the user may select the option of “More” in pop up menu 1804, indicating they do prefer image 1802, and want to see similar content. As such, similar content to image 1802 may be automatically selected and displayed in place of image 1802. Thus, decision logic 508 (FIG. 5) may select content for display that is categorized under the category of news and the topic of sea life. For instance, FIG. 20 shows page 2000 with an image 2002 displayed in place of image 1802. Image 2002 is displayed in the same position in page 1800 as was image 1802, and has a same size as image 1802. Image 2002 is categorized under the category of news and the topic of sea life (showing a swordfish), and thus relates to a same topic as image 1802.

In another case, the user may select the option of “Deep” in pop up menu 1804, indicating they do prefer image 1802, and want to see more descriptive content. As such, content more descriptive of image 1802 may be automatically selected and displayed in place of image 1802. Thus, decision logic 508 (FIG. 5) may select content for display that is categorized under the category of news and the topic of sea life, and is descriptive of the content of image 1802 (e.g., sharks). For instance, FIG. 21 shows page 2100 with an image 2102 displayed in place of image 1802. Image 2102 is displayed in the same position in page 1800 as was image 1802, and has a same size as image 1802. Image 2102 is categorized under the category of news and the topic of sea life, showing a shark, and thus shows content that is descriptive of the content of image 1802.

It is noted that in an alternative embodiment, rather than displaying selected content in place of displayed content, the selected content may be displayed in another location, including a page that is different from the page of the displayed content. For instance, when the user selects the option of “Deep” in pop up menu 1804 in FIG. 18, a new page 2200 shown in FIG. 22 may be displayed that shows selected content categorized under the category of news and the topic of sea life, and that is descriptive of the content of image 1802. Page 2200 shows an image and text that relates to a person posing for a picture with a shark, and thus shows content that is descriptive of the content of image 1802.

Furthermore, it is noted that the interactions with image 1802 with or without pop up menu 1804 may be performed using touch, motion sensing, speech recognition, or other feedback interface techniques. For instance, FIG. 23 shows a user that touches a display screen at a location of image 1802 in page 1800 to provide feedback on image 1802, as represented by a transparent hand in FIG. 23. The user may touch the screen in any manner, according to any pattern, to convey a selection of “No,” “More,” or “Deep” with respect to image 1802. For instance, the user may touch an upper portion of image 1802 in page 1800 to indicate “No,” may touch a left side portion of image 1802 in page 1800 to indicate “More,” or may touch a central portion of image 1802 in page 1800 to indicate “Deep.” In touch embodiments, any combination of touching, including finger touches/taps, dragging/swiping of fingers, double tapping or additional taps, etc., may be used to indicate selections by the user.

For instance, FIG. 24 shows an example of a finger being dragged downward on page 1800 over image 1802 to indicate “No”. Similarly, a rightward drag of a finger over image 1802 may indicate “More”, and a tap on image 1802 may indicate “Deep.”

Thus, user feedback on content may be provided in various ways, and using any combinations of feedback techniques, including combinations of touch, non-touch, motion sensing of gestures, voice, etc.

In a non-touch example, “No” and “More” may be represented by displaying clickable buttons when a pointer is hovered over content, and “Deep” may be represented by a mouse click on the content.

In a touch example, “No” may be represented by a swipe up/down, “More” may be represented by a swipe left/right, and “Deep” may be represented by tapping on the content.

In still another example that uses motion sensing of motion patterns (e.g., using a Microsoft® Kinect™device), “No” may be represented by waving your hand(s) up/down, “More” may be represented by waving your hand(s) left/right, and “Deep” may be represented by holding your hand(s) in a fist.

Note that these examples are provided for purposes of illustration, and are not intended to be limiting. It will be apparent to persons skilled in the relevant art(s) based on the teachings herein that any way of providing feedback, and combinations thereof, may be used.

### III. Example User Device and Server Embodiments

User device 102, server 104, server 500, action interpreter 108, content selector 114, web service 502, decision supporting system 504, machine learning logic 506, decision logic 508, flowchart 200, flowchart 300, flowchart 600, flowchart 700, flowchart 800, flowchart 900, and step 1002 may be implemented in hardware, or hardware combined with software and/or firmware. For example, action interpreter 108, content selector 114, web service 502, decision supporting system 504, machine learning logic 506, decision logic 508, flowchart 200, flowchart 300, flowchart 600, flowchart 700, flowchart 800, flowchart 900, and/or step 1002 may be implemented as computer program code/instructions configured to be executed in one or more processors and stored in a computer readable storage medium. Alternatively, action interpreter 108, content selector 114, web service 502, decision supporting system 504, machine learning logic 506, decision logic 508, flowchart 200, flowchart 300, flowchart 600, flowchart 700, flowchart 800, flowchart 900, and/or step 1002 may be implemented as hardware logic/electrical circuitry.

For instance, in an embodiment, one or more of action interpreter 108, flowchart 200, and/or flowchart 300 may be implemented together in a system-on-chip (SoC). Similarly, content selector 114, web service 502, decision supporting system 504, machine learning logic 506, decision logic 508, flowchart 600, flowchart 700, flowchart 800, flowchart 900, and/or step 1002 may be implemented together in a SoC. The SoC may include an integrated circuit chip that includes one or more of a processor (e.g., a central processing unit (CPU), microcontroller, microprocessor, digital signal processor (DSP), or other hardware processor), memory, one or more communication interfaces, and/or further circuits and/or optionally embedded firmware to perform its functions.

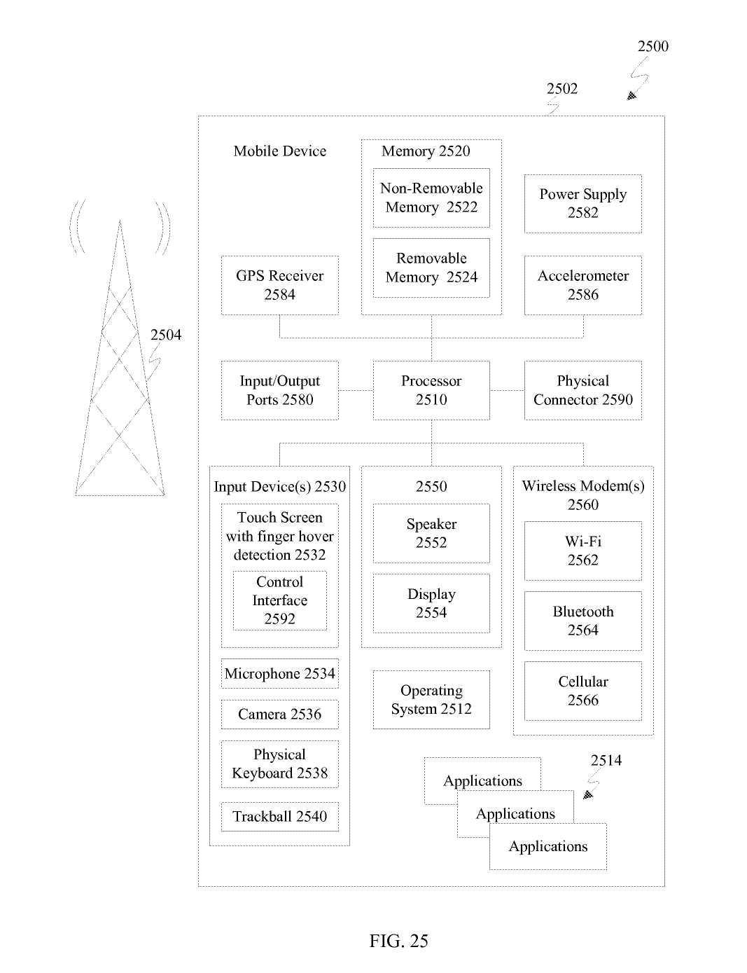

FIG. 25 shows a block diagram of an exemplary mobile device 2500 including a variety of optional hardware and software components, shown generally as components 2502. For instance, components 2502 of mobile device 2500 are examples of components that may be included in user device 102 (FIG. 1) in mobile device embodiments, but are not shown in FIG. 1 for ease of illustration. Any number and combination of the features/elements of components 2502 may be included in a mobile device embodiment, as well as additional and/or alternative features/elements, as would be known to persons skilled in the relevant art(s). It is noted that any of components 2502 can communicate with any other of components 2502, although not all connections are shown, for ease of illustration. Mobile device 2500 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 2504, such as a cellular or satellite network, or with a local area or wide area network.

The illustrated mobile device 2500 can include a controller or processor 2510 (e.g., signal processor, microprocessor, ASIC, or other control and processing logic circuitry) for performing such tasks as signal coding, data processing, input/output processing, power control, and/or other functions. An operating system 2512 can control the allocation and usage of the components 2502 and support for one or more application programs 2514 (a.k.a. applications, “apps”, etc.). Application programs 2514 can include common mobile computing applications (e.g., email applications, calendars, contact managers, web browsers, messaging applications) and any other computing applications (e.g., word processing applications, mapping applications, media player applications).

As illustrated, mobile device 2500 can include memory 2520. Memory 2520 can include non-removable memory 2522 and/or removable memory 2524. The non-removable memory 2522 can include RAM, ROM, flash memory, a hard disk, or other well-known memory storage technologies. The removable memory 2524 can include flash memory or a Subscriber Identity Module (SIM) card, which is well known in GSM communication systems, or other well-known memory storage technologies, such as “smart cards.” The memory 2520 can be used for storing data and/or code for running the operating system 2512 and the application programs 2514. Example data can include web pages, text, images, sound files, video data, or other data sets to be sent to and/or received from one or more network servers or other devices via one or more wired or wireless networks. Memory 2520 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of program modules may be stored in memory 2520. These programs include operating system 2512, one or more application programs 2514, and other program modules and program data. Examples of such application programs or program modules may include, for example, computer program logic (e.g., computer program code or instructions) for implementing user device 102, action interpreter 108 flowchart 200, and/or flowchart 300,(including any step of flowcharts 200 and 300), and/or further embodiments described herein.

Mobile device 2500 can support one or more input devices 2530, such as a touch screen 2532, microphone 2534, camera 2536, physical keyboard 2538 and/or trackball 2540 and one or more output devices 2550, such as a speaker 2552 and a display 2554. Touch screens, such as touch screen 2532, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 2532 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.25 inches and 0.05 inches, or between 0.5 inches and 0.75 inches or between 0.75 inches and 1 inch, or between 1 inch and 1.5 inches, etc.

The touch screen 2532 is shown to include a control interface 2592 for illustrative purposes. The control interface 2592 is configured to control content associated with a virtual element that is displayed on the touch screen 2532. In an example embodiment, the control interface 2592 is configured to control content that is provided by one or more of application programs 2514. For instance, when a user of the mobile device 2500 utilizes an application, the control interface 2592 may be presented to the user on touch screen 2532 to enable the user to access controls that control such content. Presentation of the control interface 2592 may be based on (e.g., triggered by) detection of a motion within a designated distance from the touch screen 2532 or absence of such motion. Example embodiments for causing a control interface (e.g., control interface 2592) to be presented on a touch screen (e.g., touch screen 2532) based on a motion or absence thereof are described in greater detail below.

Other possible output devices (not shown) can include piezoelectric or other haptic output devices. Some devices can serve more than one input/output function. For example, touch screen 2532 and display 2554 can be combined in a single input/output device. The input devices 2530 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye , and gaze tracking, immersive augmented reality and virtual reality systems, all of which provide a more natural interface, as well as technologies for sensing brain activity using electric field sensing electrodes (EEG and related methods). Thus, in one specific example, the operating system 2512 or application programs 2514 can comprise speech-recognition software as part of a voice control interface that allows a user to operate the device 2500 via voice commands. Further, the device 2500 can comprise input devices and software that allows for user interaction via a user's spatial gestures, such as detecting and interpreting gestures to provide input to a gaming application.

Wireless modem(s) 2560 can be coupled to antenna(s) (not shown) and can support two-way communications between the processor 2510 and external devices, as is well understood in the art. The modem(s) 2560 are shown generically and can include a cellular modem 2566 for communicating with the mobile communication network 2504 and/or other radio-based modems (e.g., Bluetooth 2564 and/or Wi-Fi 2562). Cellular modem 2566 may be configured to enable phone calls (and optionally transmit data) according to any suitable communication standard or technology, such as GSM, 3G, 4G, 5G, etc. At least one of the wireless modem(s) 2560 is typically configured for communication with one or more cellular networks, such as a GSM network for data and voice communications within a single cellular network, between cellular networks, or between the mobile device and a public switched telephone network (PSTN).

Mobile device 2500 can further include at least one input/output port 2580, a power supply 2582, a satellite navigation system receiver 2584, such as a Global Positioning System (GPS) receiver, an accelerometer 2586, and/or a physical connector 2590, which can be a USB port, IEEE 1394 (FireWire) port, and/or RS-232 port. The illustrated components 2502 are not required or all-inclusive, as any components can be not present and other components can be additionally present as would be recognized by one skilled in the art.

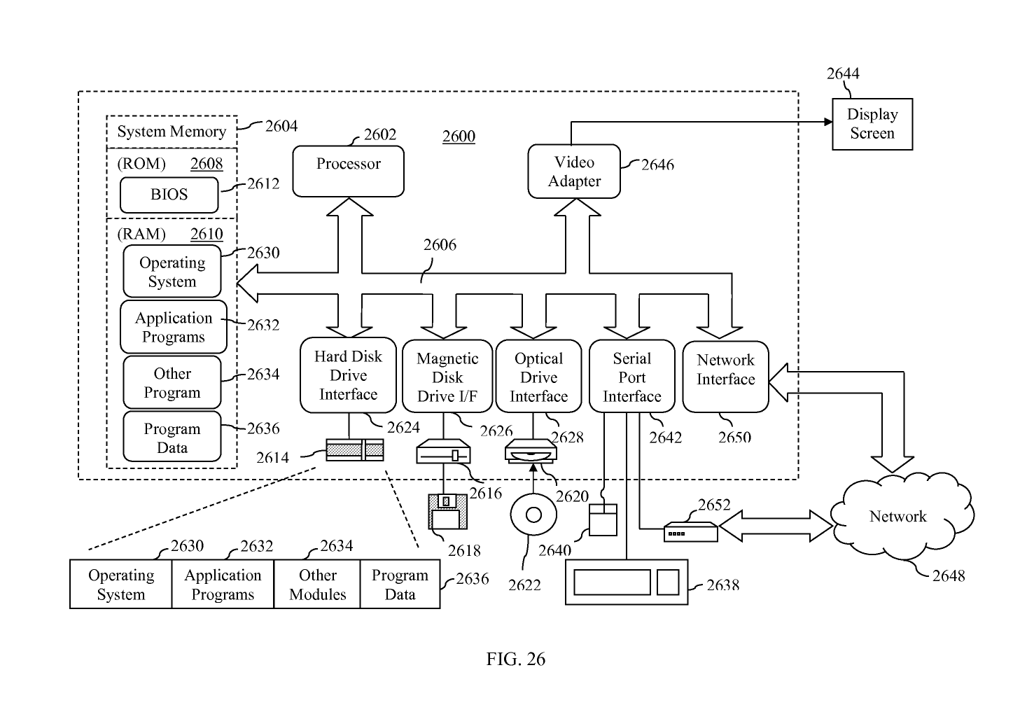

Furthermore, FIG. 26 depicts an exemplary implementation of a computing device 2600 in which embodiments may be implemented. For example, user device 102, server 104, or server 500 may be implemented in one or more computing devices similar to computing device 2600 in stationary computer embodiments, including one or more features of computing device 2600 and/or alternative features. The description of computing device 2600 provided herein is provided for purposes of illustration, and is not intended to be limiting. Embodiments may be implemented in further types of computer systems, as would be known to persons skilled in the relevant art(s).

As shown in FIG. 26, computing device 2600 includes one or more processors 2602, a system memory 2604, and a bus 2606 that couples various system components including system memory 2604 to processor 2602. Bus 2606 represents one or more of any of several types of bus structures, including a memory bus or memory controller, a peripheral bus, an accelerated graphics port, and a processor or local bus using any of a variety of bus architectures. System memory 2604 includes read only memory (ROM) 2608 and random access memory (RAM) 2610. A basic input/output system 2612 (BIOS) is stored in ROM 2608.

Computing device 2600 also has one or more of the following drives: a hard disk drive 2614 for reading from and writing to a hard disk, a magnetic disk drive 2616 for reading from or writing to a removable magnetic disk 2618, and an optical disk drive 2620 for reading from or writing to a removable optical disk 2622 such as a CD ROM, DVD ROM, or other optical media. Hard disk drive 2614, magnetic disk drive 2616, and optical disk drive 2620 are connected to bus 2606 by a hard disk drive interface 2624, a magnetic disk drive interface 2626, and an optical drive interface 2628, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and further types of physical, tangible computer-readable storage media.

A number of program modules may be stored on the hard disk, magnetic disk, optical disk, ROM, or RAM. These programs include an operating system 2630, one or more application programs 2632, other program modules 2634, and program data 2636. Application programs 2632 or program modules 2634 may include, for example, computer program logic (e.g., computer program code or instructions) for implementing user device 102, server 104, server 500, action interpreter 108, content selector 114, web service 502, decision supporting system 504, machine learning logic 506, decision logic 508, flowchart 200, flowchart 300, flowchart 600, flowchart 700, flowchart 800, flowchart 900, and step 1002 (including any step of flowcharts 200, 300, 600, 700, 800, and 900), and/or further embodiments described herein.

A user may enter commands and information into the computing device 2600 through input devices such as keyboard 2638 and pointing device 2640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 2602 through a serial port interface 2642 that is coupled to bus 2606, but may be connected by other interfaces, such as a parallel port, game port, or a universal serial bus (USB).

A display screen 2644 is also connected to bus 2606 via an interface, such as a video adapter 2646. Display screen 2644 may be external to, or incorporated in computing device 2600. Display screen 2644 may display information, as well as being a user interface for receiving user commands and/or other information (e.g., by touch, finger gestures, virtual keyboard, etc.). In addition to display screen 2644, computing device 2600 may include other peripheral output devices (not shown) such as speakers and printers.

Computing device 2600 is connected to a network 2648 (e.g., the Internet) through an adaptor or network interface 2650, a modem 2652, or other means for establishing communications over the network. Modem 2652, which may be internal or external, may be connected to bus 2606 via serial port interface 2642, as shown in FIG. 26, or may be connected to bus 2606 using another interface type, including a parallel interface.

As used herein, the terms “computer program medium,” “computer-readable medium,” and “computer-readable storage medium” are used to generally refer to media such as the hard disk associated with hard disk drive 2614, removable magnetic disk 2618, removable optical disk 2622, memory 2520 (including non-removable memory 2522 and removable memory 2524), flash memory cards, digital video disks, RAMs, ROMs, and further types of physical/tangible storage media. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 2632 and other program modules 2634) may be stored on the hard disk, magnetic disk, optical disk, ROM, or RAM. Such computer programs may also be received via network interface 2650, serial port interface 2642, or any other interface type. Such computer programs, when executed or loaded by an application, enable computing device 2600 to implement features of embodiments discussed herein. Accordingly, such computer programs represent controllers of the computing device 2600.

As such, embodiments are also directed to computer program products comprising computer instructions/code stored on any computer useable storage medium. Such code/instructions, when executed in one or more data processing devices, causes a data processing device(s) to operate as described herein. Examples of computer-readable storage devices that may include computer readable storage media include storage devices such as RAM, hard drives, floppy disk drives, CD ROM drives, DVD ROM drives, zip disk drives, tape drives, magnetic storage device drives, optical storage device drives, MEMs devices, nanotechnology-based storage devices, and further types of physical/tangible computer readable storage devices.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
providing a content for display; and
enabling content feedback in association with the displayed content, including
enabling a user to interact with the displayed content to indicate a first preference that the displayed content is not preferred and be replaced with a display of a replacement content,
enabling the user to interact with the displayed content to indicate a second preference that the displayed content is preferred and that additional content regarding a same topic as the displayed content be displayed, and
enabling the user to interact with the displayed content to indicate a third preference that the displayed content is preferred and that additional content providing additional information about the displayed content be displayed.

2. The method of claim 1, wherein said enabling content feedback in association with the displayed content further comprises:
displaying a graphical user interface element that includes a first option that may be interacted with to indicate the first preference, and a second option that may be interacted with to indicate the second preference.

3. The method of claim 2, wherein said enabling content feedback in association with the displayed content further comprises:
displaying the graphical user interface element that further includes a third option that may be interacted with to indicate the third preference.

4. The method of claim 2, wherein said enabling content feedback in association with the displayed content further comprises:
enabling the third preference to be indicated by a mouse click on the content.

5. The method of claim 2, wherein said displaying a graphical user interface element comprises:
displaying the graphical user interface element in response to the user positioning a pointer over the content.

6. The method of claim 2, wherein the graphical user interface element is a pop up menu.

7. The method of claim 1, wherein said enabling content feedback in association with the displayed content further comprises:
enabling the first preference to be indicated by a first touch pattern;
enabling the second preference to be indicated by a second touch pattern; and
enabling the third preference to be indicated by a third touch pattern.

8. The method of claim 1, wherein said enabling content feedback in association with the displayed content further comprises:
enabling the first preference to be indicated by a first motion pattern;
enabling the second preference to be indicated by a second motion pattern; and
enabling the third preference to be indicated by a third motion pattern.

9. The method of claim 1, wherein said providing a content for display comprises:
providing at least one of text or an image for display.

10. A method in a server for selecting next content in response to user interaction with content displayed at a user device, comprising:
receiving from the user device a package that identifies the displayed content and includes a user preference indication that indicates a user preference of a user regarding the displayed content determined based on an interaction with the displayed content;
determining a next content to be displayed at the user device based on the identified displayed content and the user preference indication; and
providing the next content to the user device.

11. The method of claim 10, wherein said receiving comprises:
receiving the package, the package including an indication of a first category identifier that indicates a category of the displayed content, a first topic identifier that indicates a topic of the displayed content, a first item identifier that identifies the displayed content, and the user preference indication.

12. The method of claim 11, wherein said determining comprises:
selecting a second category identifier, a second topic identifier, and a second item identifier when the user preference indication indicates the displayed content is not preferred; and
the method further comprising:
retrieving the next content according to the second category identifier, the second topic identifier, and the second item identifier.

13. The method of claim 11, wherein said determining comprises:
selecting a second topic identifier and a second item identifier when the user preference indication indicates the displayed content is preferred and that additional content having a same category as the displayed content be displayed; and
the method further comprising:
retrieving the next content according to the first category identifier, the second topic identifier, and the second item identifier.

14. The method of claim 11, wherein said determining comprises:
selecting a second item identifier when the user preference indication indicates the displayed content is preferred and that additional content providing additional information about the displayed content be displayed; and
the method further comprising:
retrieving the next content according to the first category identifier, the second topic identifier, and the second item identifier.

15. The method of claim 11, further comprising:
performing machine learning on the first category identifier, the first topic identifier, the first item identifier, and the user preference indication to adjust a decision algorithm used to perform said determining.

16. A server configured to select next content in response to user interaction with content displayed at a user device, comprising:
a web service configured to receive from the user device an indication of a first category identifier that indicates a category of the displayed content, a first topic identifier that indicates a topic of the displayed content, a first item identifier that identifies the displayed content, and a user preference indication that indicates a preference of a user regarding the displayed content determined based on an interaction with the displayed content; and
decision logic configured to determine the next content to be displayed at the user device based on the first category identifier, the first topic identifier, the first item identifier, and the user preference indication; and
the web service configured to access the next content from content storage and to provide the next content to the user device for display in place of the displayed content in a displayed page, the next content to be displayed in the displayed page in a same size and a same position as was the displayed content.

17. The server of claim 16, wherein the decision module is configured to select a second category identifier, a second topic identifier, and a second item identifier when the user preference indication indicates the displayed content is not preferred; and
the web service is configured to retrieve the next content according to the second category identifier, the second topic identifier, and the second item identifier.

18. The server of claim 16, wherein the decision module is configured to select a second topic identifier and a second item identifier when the user preference indication indicates the displayed content is preferred and that additional content having a same category as the displayed content be displayed; and
the web service is configured to retrieve the next content according to the first category identifier, the second topic identifier, and the second item identifier.

19. The server of claim 16, wherein the decision module is configured to select a second item identifier when the user preference indication indicates the displayed content is preferred and that additional content providing additional information about the displayed content be displayed; and
the web service is configured to retrieve the next content according to the first category identifier, the second topic identifier, and the second item identifier.

20. The server of claim 16, further comprising:
machine learning logic configured to perform machine learning on the first category identifier, the first topic identifier, the first item identifier, and the user preference indication to adjust a decision algorithm used by the decision logic.
